(19) United States
(12) Patent Application Publication
(10) Pub. No.: US 2010/0166915 A1
(43) Pub. Date: Jul. 1, 2010

(54) CARBONATED BEVERAGE CONTAINING POLYUNSATURATED FATTY ACIDS

(75) Inventors: Janne Sande Mathisen, Oslo (NO); Henrik Mathisen, Oslo (NO)

Correspondence Address: FITZPATRICK CELLA HARPER & SCINTO, 1290 Avenue of the Americas, NEW YORK, NY, 10104-3800, US

(73) Assignee: PHARMALOGICA AS, Oslo (NO)

(21) Appl. No.: 12/664,421

(22) PCT Filed: Jun. 23, 2008
(86) PCT No.: PCT/NO2008/000234

§ 371 Date: Jan. 19, 2010

(30) Foreign Application Priority Data
Jun. 25, 2007 (NO) 20073267

(51) Int. Cl. A23L 2/54; A23L 1/30; A23L 2/44

(52) U.S. Cl. 426/61; 426/590; 426/580; 426/583; 426/599; 426/542; 426/72; 426/477

(57) ABSTRACT

The present invention relates to a carbonated beverage comprising polyunsaturated fatty acids (PUFA) or derivatives thereof in an oil-in-water emulsion and the preparation thereof

### FIELD OF INVENTION

The present invention relates to a carbonated beverage comprising polyunsaturated fatty acids (PUFA) or derivatives thereof in an oil-in-water emulsion, and the preparation thereof.

### DESCRIPTION OF PRIOR ART

PUFA are long chain fatty acids containing two or more double bonds and it is well known that such unsaturated lipids or fatty acids are beneficial to the consumer. PUFA is interesting both as health promoting ingredients of our every day diet and also as therapeutics. PUFA occur throughout animal, plant, algae, fungi and bacteria and are widely found as many lipid compounds in membranes, storage oils, glycolipids, phospholipids, sphingolipids and lipoproteins.

Fatty acids are the building blocks of dietary fats. The human body stores such dietary fats substantially in the form of triglycerides. Triglycerides containing omega-3 fatty acids are mainly found in fish. Stabilisation of PUFA against oxidation is an important task in food processing.

It is becoming increasingly recognised that when oils are kept stable and the oxidation is kept to a minimum, the health value of the oil is greater. PUFA undergo extensive oxidative deterioration during storage, marketing, or deep fat-frying. These secondary products adversely affect flavour, aroma, taste, nutritional value and overall quality of foods. In the case of fish oils, the oxidation leaves a characteristic taste and the consumer can easily recognize the decrease in quality. However, in the case of vegetable oils, the decrease in quality due to oxidation is not that easy recognised.

Working with unsaturated lipid or fatty acid preparations shows that it is extremely difficult to prevent the oxidation of fatty acids. Event thought the processing and storage are conducted in an inert atmosphere, and the product are filled on air tight containers, it has been difficult to prevent the oxidation completely and to offer a product where the unpleasant taste of for example fish oil is eliminated or fully masked and no unpleasant aftertaste is present.

The importance of a balanced PUFA intake has been recognised by health organisations throughout the world over the past decade. There is now some consensus that PUFAs should form a bare minimum of 3%, and preferably 10-20%, of the total lipid intake.

There is a challenge today to compose a diet containing a sufficient amount of polyunsaturated fatty acids. A typical diet today gives a lack of the essential fatty acids, especially omega-3. The Health authorities in Norway, Mattilsynet, are now actively advising the public to eat fish for dinner 4 times a week. This is not a possible or desired option by most families. This invention makes it easier to meet the daily recommended dose of health promoting polyunsaturated fatty acids.

The population of the western world does consume a huge amount of sugar containing soft drinks every day. There is a declared goal from WHO to reduce the consumption of sugar containing soft drinks due to the high risk of developing diabetes mellitus.

It is well known from the beer and soda industry that adding carbon dioxide to drinks leaves a fresh and tasty beverage.

Also known are carbon dioxide used as a preservative when packing foodstuffs due the reduction or inhibition of bacterial growth. However, it is not known to be used as an agent stabilizing the unsaturated fatty acids and thus eliminate the oxidation.

The Norwegian Patent No 322041, and the Norwegian Patent Applications 20053136 and 20055620 describe different oil-in water emulsions wherein the oxidation of the polyunsaturated fatty acids has been eliminated or reduced to an acceptable level. However, prior art does not teach use of carbon dioxide to stabilize the oil-in-water emulsion and to prevent oxidation of fatty acids.

### PRESENT INVENTION

Through the present invention it has surprisingly been found that addition of carbon dioxide to an oil-in-water emulsion of unsaturated lipids or fatty acids stabilizes the oxidation of fatty acids, revealing a stable and tasty beverage.

One aspect of the present invention is to increase the intake of PUFA. Thus, the present invention provides a beverage serving as a food supplement containing health promoting essential polyunsaturated fatty acids and derivatives thereof, facilitating intake of daily recommended dosage.

Another aspect of the present invention is to reduce the oxidation rate of PUFA. Thus, the present invention provides a carbonated beverage containing PUFA wherein the oxidation of the lipids or fatty acids are reduced to a minimum. The addition of carbon dioxide eliminates or stabilises the oxidation of polyunsaturated fatty acids. The carbon dioxide in the composition displaces the oxygen and reduces the pH.

Another aspect of the present invention is to maintain a pleasant taste or mask the unpleasant taste of PUFA, especially fish oil. Thus, the present invention provides a carbonated beverage containing PUFA with a pleasant taste and aftertaste.

Another aspect of the present invention is to reduce the intake of sugar containing drinks. Thus, the present invention provides a sparkling beverage being a drink of choice, resulting in a reduced intake of sugar containing soft drinks.

Another aspect of the present invention is to provide a tempting drink, which will contribute to the maintenance of the water balance and be a drink of choice to thirsty people.

Another aspect of the present invention is to provide a process for production of beverage according to the invention, and a sealed container comprising said beverage.

These and further aspects are achieved by the present invention.

### DETAILED DESCRIPTION OF THE INVENTION

The present invention provides a beverage comprising polyunsaturated fatty acids (PUFA) or derivatives thereof in an oil-in-water emulsion wherein said beverage is carbonated.

The oil or fatty acids to be used in the beverage of the present invention may be any edible unsaturated fatty acid or derivative thereof extracted from an animal or vegetable source. Examples of suitable oils are oils of marine origin such as fish oil and krill oil. The oils may contain any unsaturated fatty acids, examples of such fatty acids are: omega-3-, omega-6- and omega-9-fatty acids such as linolenic acid (LA), arachidonic acid (AA), eicosapentaenoic acid (EPA) and docosahexaenoic acid (DHA).

Examples of vegetable oils with high content of polyunsaturated fatty acids are flaxseed oil, linseed oil, corn, rapeseed, canola, soybean, sunflower, olive, borage oil, echium oil, walnut oil, almond oil, peanut oil, avocado oil, cucumber oil, evening primrose oil, hemp oil.

The content of oil is the present invention may vary over a wide range. Typically the oil content is between 0.1-7% by weight based on the total weight. However, this will depend on the nature of oil of interest.

The carbon dioxide may be introduced by any technology known to the person skilled in the art especially within the field of soda and beer production. The content of CO₂ may vary over a wide range.

The emulsifier according to the present invention can be any emulsifier as long as an adequate oil-in-water emulsion is provided. Examples of suitable emulsifiers are soya lecithin, whey protein and milk solids.

The beverage according to the present invention may further comprise juice either in the form of a concentrate or fresh pressed juice. Preferably, said juice originates from fruit, berry or vegetables having a suitable high level of antioxidants. The content of juice may vary over a wide range. Suitable examples of fruit, berries and vegetables include, but are not limited to apple, pomegranate, apricot, grapefruit, orange, cranberry, rosehips, pineapple, black chokeberries (aronia), mulberry, cloudberry, acerola, raspberries, watermelon, grapes, cherries, jambolao, gala apples, mango, kiwi, bilberry, blackberry, blueberry, boysenberry, gooseberry, raspberry, strawberry, carrots, banana, passion fruit, lime, mango, nectarine, peaches, plums, galia and honey dew or any combination thereof.

The beverage according to the present invention may further comprise tea, preferably tea with suitable high level of antioxidants such as green tea, black tea and rooibos tea.

The beverage according to the present invention may further comprise probiotics. Suitable examples of probiotics include, but are not limited to, lactobacillus and bifidobacterium.

The beverage according to the present invention may further comprise sweeteners, flavoring agents, antioxidants, vitamins, minerals and preservatives. Suitable non-limiting example of preservative includes potassium sorbate and a suitable non-limiting example of sweetener includes sucralose and xylitol.

Further, the present invention relates to a process for the preparation of a beverage comprising the following steps:
a) water soluble additives are solubilised in water
b) emulsifier and oil soluble additives are mixed with the oil of interest under continuous but gentle stirring
c) the oil phase of b) is added slowly under continuous but gentle stirring to the water phase of a) obtaining a homogenous oil-in-water emulsion;
d) CO₂ is added, and
e) the composition is filled on suitable air tight sealed containers under inert atmosphere.

The beverage may optionally comprise juice or juice concentrate, which may be added either to the water phase, especially fresh pressed juice or to the resultant emulsion, especially juice concentrate.

The present invention also relates to a sealed container comprising a beverage according to the invention.

The present invention will now be further described with reference to the following non-limiting examples.

### EMBODIMENTS

### Example 1

The composition of example 1 was prepared as outlined below. The emulsifier used was milk solid and the PUFA used was salmon oil.

| Composition in percentages (w/w) | With juice | Without juice |
|---|---|---|
| Water | 79.94 | 96.67 |
| Apple concentrate | 12.51 | — |
| Pomegranate apple concentrate | 2.40 | — |
| Aronia concentrate | 0.80 | — |
| Passion fruit concentrate | 0.32 | — |
| Fish oil | 2.00 | 2.00 |
| Potassium Sorbate | 0.05 | 0.05 |
| Grindsted FF 1125 | 1.70 | 1.00 |
| Guardian Rosemary Extract | 0.02 | 0.02 |
| Grindox Toco 50 Antioxidant | 0.01 | 0.01 |
| Jackfruit Flavoring | 0.15 | 0.15 |
| Carbon dioxide | Yes | Yes |
| Total | 100.00 | 100.00 |

Immediately following production, both drinks had a homogenous appearance indicating a well formed emulsion. The viscosity was low leaving drinks which are easy to swallow. No smell or taste of fish oil could be experienced on neither drinks. No fishy aftertaste was experienced.

### Process of Production

The beverages of Example 1 were prepared by the following steps:
a) water soluble additives are solubilised in water
b) emulsifier and oil soluble additives are mixed with the oil of interest under continuous but gentle stiffing
c) the oil phase of b) is added slowly under continuous but gentle stiffing to the water phase of a) obtaining a homogenous oil-in-water emulsion;
d) CO₂ is added, and
e) the composition is filled on suitable air tight sealed containers under inert atmosphere.

The sequence of the steps can be varied as long as a beverage of appropriate quality is achieved. The composition is optionally combined with suitable juice or juice concentrate, either added to the water phase or to the emulsion.

In full scale industrial production the process may further comprise a step of pasteurization, i.e. rapid heat treatment.

The PUFA may be any PUFA. The juice may be any suitable juice or juice concentrate or combinations thereof as outlined above.

The containers may preferably be small bottles ready to be used. Bottles containing different amounts of PUFA adjusted to the recommended daily dose of adults, children and infant are possible. The containers may be unit dose containers or multi dose containers equipped with a stopper or screw cap. The processing and packaging are preferably conducted under an inert atmosphere at room temperature.

The fish oil is provided by Marine Harvest Ingredients, Norway, as Xalar oil.

The following ingredients are commercially available by Danisco A/S, Langebrogade 1, DK-1001 Copenhagen:

GRINDSTED® FF 1125 Stabiliser System (E 1422, milk solids, E 1442, E 415)
Jackfruit Flavouring T 10729 (NI, liquid)
GRINDOX™ TOCO 50 Antioxidant (E 306, rapeseed oil)
GUARDIAN™ Rosemary Extract 201 (natural rosemary extract)
The fruit juice concentrates are available from:
Apple concentrate: Pfanner Hermann GmbH
Pommegranat and Aronia concentrates: Sunprojuice
Passion fruit concentrate: Skandjuice N. V.

### Performance/Stability

As indicated above, the beverages performed excellent immediately after completing the production.

The beverage containing juice concentrate according to Example 1 were tested with respect to stability.

Samples of the beverage were tested at start (day 0), and after 5 days. Control samples not exposed to CO₂ were prepared.

### Exposure to CO₂:

500 ml beverage was transferred to 2×1 L bottles and CO₂ was added as dry ice. The test samples were allowed to stand at room temperature for 5 days. The atmosphere in the bottle was then exchanged from CO₂/air to an inert N₂ atmosphere. Thereafter the test samples were frozen and stored until further analysis.

### No Exposure to CO₂:

500 ml beverage was transferred to 2×1 L bottles, corked and thoroughly shaken and allowed to stand at room temperature for 5 days. The atmosphere in the bottle was then exchanged from air to an inert N₂ atmosphere. Thereafter the test samples were frozen and stored until further analysis.

TABLE 1

| | | Day 5 | Day 5 |
|---|---|---|---|
| | Day 0 | carbonated | non-carbonated |
| Fatty acids % | 1.6 | 1.6 | 1.5 |
| Anisidine | <1 | <1 | 2 |
| value (meq/kg) | | | |
| Peroxide | 11.9 | 17.9 | 23.7 |
| value (meq/kg) | | | |

As apparent from table 1, the anisidine value of the carbonated beverage is unchanged after 5 days, while the aniside value of the non-carbonated beverage was significantly increased from below 1 to 2.

The peroxide value of the non-carbonated beverage increased by 100% from 11.9 meq/kg to 23.7 meq/kg during five days, while the peroxide value of the carbonated beverage increased only by 50% to 17.9 meq/kg.

This shows that adding carbon dioxide to a beverage containing PUFA significantly reduces the oxidation of the fatty acids in the composition.

In addition to the anisidine value and peroxide value, the chemical composition of fatty acids was analysed. As apparent from table 2 below, no changes in the chemical composition of fatty acids was observed after five days.

TABLE 2

| | | | Day 5 | Day 5 |
|---|---|---|---|---|
| | | Day 0 | carbonated | non-carbonated |
| Fatty acids | | 1.6 | 1.5 | 1.6 |
| SFA | g/100 g | 0.29 | 0.27 | 0.29 |
| MUFA | g/100 g | 0.69 | 0.64 | 0.67 |
| PUFA | g/100 g | 0.52 | 0.49 | 0.51 |
| Omega-3 | g/100 g | 0.31 | 0.30 | 0.31 |
| Omega-6 | g/100 g | 0.16 | 0.15 | 0.16 |

SFA; saturated fatty acids
MUFA; monounsaturated fatty acids
PUFA; polyunsaturated fatty acids

### Example 2

The composition of example 2 was prepared as example 1. The emulsifier used was milk solid and the PUFA used was “Udo's choice”. CO₂ was added by using Soda Stream machine. One half was maintained non-carbonated.

| Composition in percentages (w/w) | Carbonated | Non-carbonated |
|---|---|---|
| Apple juice | 93.47 | 93.47 |
| “Udo's choice oil” | 5.00 | 5.00 |
| Blackcurrant nat. aroma | 0.15 | 0.15 |
| Potassium Sorbate | 0.05 | 0.05 |
| Grindsted FF 1125 | 1.30 | 1.30 |
| Guardian Rosemary Extract | 0.02 | 0.02 |
| Grindox Toco 50 Antioxidant | 0.01 | 0.01 |
| Carbon dioxide | Yes | No |
| Total | 100.00 | 100.00 |

“Udo's Choice” is a blend of vegetable oils rich in PUFA and EFA (essential fatty acids) provided internationally by the company Flora. In Norway the product is commercial available from Soma Nordic AS, Nedre Vollsgate 9, 0158 Oslo. Udo's choice contains oils from organic flax, sesame, sunflower, evening primrose, rice and oat germ.

Immediately following production, both compositions had a homogenous appearance indicating a well formed emulsion. The viscosity was low, leaving drinks which are easy to swallow, although the consistency was somewhat oily due to the higher content of oil. No smell or taste of PUFA could be experienced.

The stability of the composition of Example 2 (with or without CO₂) was studied during a period of 4 days at room temperature (20-25° C.). The bottles were opened and closed 3 times a day. The smell and taste were registered throughout the test period.

### Results

No changes in the formulations were observed throughout the observation period. The carbonated and the non-carbonated drinks performed equally well.

However, the carbonated drink was observed to better maintain the fresh, aromatic taste and an easy to swallow characteristic. The non-carbonated drink was less fresh and had a weaker aroma and an oilier consistence.

### Example 3

The composition of example 3 was prepared as outlined in Example 1. The emulsifier used was whey protein concentrate and the PUFA used was hazelnut oil. CO₂ was added by using Soda Stream machine.

| Composition in percentages (w/w) | |
|---|---|
| Apple juice | 96.07 |
| Potassium sorbate | 0.05 |
| Rosemary extract 201 | 0.02 |
| Toco 50 | 0.01 |
| Whey protein concentrate (WPC) | 1.70 |
| Pineapple nat. | 0.15 |
| Hazelnut oil | 2.00 |
| Carbon dioxide | Yes |
| sum | 100.00 |

pH 4.2

Immediately following production, the composition had a homogenous appearance indicating a well formed emulsion. The viscosity was low, leaving a drink which was easy to swallow. This carbonated drink was fresh with a nice fruity taste. No smell or taste of PUFA could be experienced.

Ingredients are Provided from:
Apple juice concentrate: Pfanner Hermann GmbH
Whey protein concentrate: Arla food Ingredients
Pineapple natural flavouring: Danisco A/S, Langebrogade 1, DK-1001 Copenhagen:
Hazelnut Oil: Oluf Lorenzten import & engros as, Lindeberg gård, Oslo

### Example 4

The composition of example 4 was prepared as outlined in Example 1. The emulsifier used was whey protein concentrate and the PUFA used was avocado oil. CO₂ was added by using Soda Stream machine.

| Composition in percentages (w/w) | |
|---|---|
| Orange juice | 95.27 |
| Potassium sorbate | 0.05 |
| Rosemary extract 201 | 0.02 |
| Toco 50 | 0.01 |
| Whey protein concentrate (WPC) | 1.50 |
| Mandarin nat. | 0.15 |
| Avocado oil | 3.00 |
| Carbon dioxide | Yes |
| sum | 100.00 |

pH 3.8

Immediately following production, the composition had a homogenous appearance indicating a well formed emulsion. The viscosity was low, leaving drinks which are easy to swallow. The carbonated drink had a fresh fruity taste and smell. No smell or taste of PUFA could be experienced

Orange Juice concentrate: Harlem Foods, Oslo
Avocado oil: Oluf Lorenzten import & engros as, Lindeberg gård, Oslo
Mandarin natural flavouring: Danisco

### Example 5

The composition of example 5 was prepared as outlined in Example 1. The emulsifier used was whey protein concentrate and the PUFA used was vitago mixed oil. CO₂ was added as dry ice.

| Composition in percentages (w/w) | |
|---|---|
| Green tea with lime | 96.92 |
| Potassium sorbate | 0.05 |
| Rosemary extract 201 | 0.02 |
| Toco 50 | 0.01 |
| Whey protein concentrate (WPC) | 1.50 |
| Vitago mixed oil | 1.50 |
| Carbon dioxide | Yes |
| sum | 100.00 |

pH 4.0

Immediately following production, the composition had a homogenous appearance indicating a well formed emulsion. The viscosity was low, leaving drinks which are easy to swallow. The carbonated drink had a fresh fruity taste and smell. No smell or taste of PUFA could be experienced

Green tea with lime: TINE Norwegian Dairies
Vitago mixed oil: Mills

### Example 6

The composition of example 6 was prepared as outlined in Example 1. The emulsifier used was milk solid and the PUFA used was evening primrose oil. CO₂ was added as dry ice.

| Composition in percentages (w/w) | |
|---|---|
| Green tea with lime | 97.92 |
| Potassium sorbate | 0.05 |
| Rosemary extract 201 | 0.02 |
| Toco 50 | 0.01 |
| Grindsted 1125 | 1.00 |
| Evening primrose oil | 1.00 |
| Carbon dioxide | Yes |
| sum | 100.00 |

pH 3.6

Immediately following production, the composition had a homogenous appearance indicating a well formed emulsion. The viscosity was low leaving drinks which are easy to swallow. The carbonated drink had a fresh fruity taste and smell. No smell or taste of PUFA could be experienced

### Evening Primrose oil: Sunkost Detaljk, Thunesvei 2, Oslo

### Example 7

The composition of example 7 was prepared as outlined in Example 1. The emulsifier used was milk solid and the PUFA used was fish oil. In addition probiotics was added. CO₂ was added by using Soda Stream machine.

| Composition in percentages (w/w) | |
|---|---|
| Freshly pressed orange juice | 86.45 |
| Fish oil | 5.00 |
| Potassium sorbate | 0.10 |
| Xylitol | 5.00 |
| Citric acid | 0.25 |
| GRINDSTED FF 1125 | 3.00 |
| Guardian Rosemary extract | 0.02 |
| Grindox Toco 50 antioxidant | 0.01 |
| Jackfruit Flavouring | 0.15 |
| Acidophilus 300 GL | 0.02 |
| Carbon dioxide | Yes |
| Total | 100.00 |

Immediately following production, the composition had a homogenous appearance indicating a well formed emulsion. The viscosity was low, leaving drinks which are easy to swallow, although the consistency was somewhat oily, due to the higher content of oil. The carbonated drink had a fresh fruity taste and smell. No smell or taste of fish oil could be experienced.

### Xylitol: Danisco

Acidophilus 300 GL: Lactobacillus acidophilus NCFM; Danisco A/S, Langebrogade

### 1, DK-1001 Copenhagen

### Example 8

The aim of this study was to show that adding CO₂ to a PUFA emulsion affects the oxidative status of the composition.

Two different compositions where produced in industrial scale at NEN PRODUCTS AS, Fredrikstad, the batch sizes being 2000 kg. The samples were filled in aseptic Tetra Pack packaging. The compositions were identified Recharge and Vibrant, respectively. The emulsifiers of both compositions were Grindsted 3115. The PUFA of Recharge was fish oil, and the PUFA of Vibrant was fish oil and evening primrose oil.

The oxidative status of the samples, where analysed at Matforsk, Norwegian Food, Fisheries and Aquaculture Research.

Recharge had the following composition:

| Recharge | % | kg |
|---|---|---|
| Rosemary extract 201 | 0.02 | 0.40 |
| Toco 50 | 0.01 | 0.20 |
| Grindsted 3115 | 1.00 | 20.00 |
| Apple concentrate | 9.00 | 180.00 |
| Pommegranat conc | 2.50 | 50.00 |
| Aronia concentrate | 0.80 | 16.00 |
| Pear concentrate | 2.90 | 58.00 |
| Water | 78.04 | 1562.80 |
| Mandarine | 0.20 | 4.00 |
| Lychee | 0.02 | 0.40 |
| Whey protein * | 4.00 | 80.00 |
| Trisodiumcitrat * | 0.01 | 0.20 |
| Fish oil | 1.50 | 30.00 |
| | 100.00 | 2000.00 |

* Natural Mandarine aroma from Firmenich
* Natural Lychee aroma from Firmenich
* Lacprodan DI - 9213 - whey protein isolate powder - from Arla Foods

Vibrant had the following composition:

| Vibrant | % | kg |
|---|---|---|
| Rosemary extract 201 | 0.0200 | 0.40 |
| Toco 50 | 0.010 | 0.20 |
| Whey protein powder | 0.300 | 6.00 |
| Grindsted 3115 | 1.000 | 20.00 |
| Apple concentrate | 9.450 | 189.00 |
| Pommegranat conc | 2.400 | 48.00 |
| Aronia conc | 0.880 | 17.60 |
| Pear conc | 3.000 | 60.00 |
| Vann, renset | 81.000 | 1620.00 |
| Lemon * | 0.030 | 0.60 |
| Apricot * | 0.200 | 4.00 |
| Fish oil | 1.200 | 24.00 |
| EPO * | 0.500 | 10.00 |
| Matcha tea * | 0.010 | 0.20 |
| | 100.000 | 2000.00 |

Lemon aroma from Firmenich: 987 317
Apricot aroma from Firmenich: 550 317 T
EPO: Evening primrose oil from Bioriginal
Matcha Tea: powder from green tea leaves from Ayia Gmbh

Samples from both compositions were treated as follows:
1) Samples were added CO₂ just before filling into the Tetra packaging, and the samples were identified Recharge K and Vibrant K, respectively.
2) Samples were flushed with nitrogen (nitrogen headspace), and the samples were identified simply Recharge and Vibrant, respectively.
3) Samples with air headspace, and the samples were identified Recharge A and Vibrant A, respectively.

All samples were stored at 40° C. for 18 days. All samples were stored in parallels.

### Analysis—Oxidative Status

Dynamic headspace-Gas Chromatography Mass spectrometry (GCMS) of volatile oxidation products were used for studying oxidation of the drinks. 15 grams of drinks was weighed into Erlenmeyer bottles and ethyl heptanoate in methanol was added as internal standard. Then the samples were placed in a water bath at 70° C. and purged for 15 minutes with nitrogen, 100 ml/min. Volatile compounds were trapped on an adsorber (Tenax GR), desorbed at 280° C. for 5 minutes in a Markes Thermal Desorber and transferred to an Agilent 6890 GC with an Agilent 5973 Mass Selective Detector (El, 70 eV). The volatiles were separated on a DB-WAXetr column (30 m, 0.25 mm i.d., 0.5 μm film) with a temperature program starting at 30° C. for 10 min, increasing 1° C./min to 40° C., 3° C./min to 70° C. and 6.5° C./min to 230° C., hold time 5 min. The peaks were integrated and compounds tentatively identified with HP Chemstation software, Wiley 130K Mass Spectral Database and NIST98 Mass Spectral Library. System performance was checked with blanks and standard samples before and after analysis. The samples were analysed in duplicate.

### Results

Table 3 shows the development of different volatile oxidation product in samples stored at 40° C. for 18 days.

TABLE 3

| | Recharge K [symbol] | Recharge | Recharge A | Vibrant K | Vibrant | Vibrant A |
|---|---|---|---|---|---|---|
| pentanal | 2.18 | 4.08 | 11.60 | 1.27 | 25.81 | 7.07 |
| hexanal | 1.11 | 1.27 | 0.69 | 4.73 | 8.17 | 6.62 |
| 1-penten-3-ol | 0.00 | 0.00 | 0.42 | 0.10 | 0.00 | 0.50 |
| 2-pentenal | 0.00 | 0.00 | 0.21 | 11.21 | 3.41 | 12.68 |
| 2-hexenal | 0.00 | 0.18 | 0.00 | 8.86 | 4.00 | 18.64 |
| octanal | 2.27 | 4.69 | 5.39 | 32.47 | 100.40 | 95.75 |
| nonanal | 0.00 | 0.00 | 2.46 | 20.20 | 32.59 | 29.51 |
| 2-octenal | 0.00 | 0.00 | 0.00 | 2.04 | 2.42 | 1.08 |
| 1-octen-3-ol | 0.00 | 0.00 | 0.74 | 0.00 | 0.91 | 2.26 |
| decanal | 3.51 | 8.15 | 7.96 | 10.40 | 14.39 | 31.46 |

[symbol]

indicates data missing or illegible when filed

Recharged K showed a significant lower concentration of volatile oxidation products than Recharge and Recharge A. Particularly, the content of pentanal increased from 2.18 ng/g (Recharge K) to 4.08 ng/g (Recharge) and 11.60 ng/g (Recharge A). The content of octanal increased from 2.27 ng/g (Recharge K) to 4.69 ng/g (Recharge) and 5.39 ng/g (Recharge A) and the content of decanal increased from 3.51 ng/g (Recharge K) to 8.15 ng/g (Recharge) and 7.96 ng/g (Recharge A).

Similarly, Vibrant K showed a significant lower concentration of volatile oxidation products than Vibrant and Vibrant A. Particularly, the content of pentanal increased from 1.27 ng/g (Vibrant K) to 25.81 ng/g (Vibrant) and 7.07 ng/g (Vibrant A). The content of octanal increased from 32.47 ng/g (Vibrant K) to 100.40 ng/g (Vibrant) and 95.75 ng/g (Vibrant A) and the content of decanal increased from 10.40 ng/g (Vibrant K) to 14.39 ng/g (Vibrant) and 31.46 ng/g (Vibrant A)

Traces of 1-penten-3-ol, which is a well known marker for early oxidation of fish oils, appears in both Recharge A and Vibrant A, i.e. the samples containing air in headspace.

This shows that adding CO₂ to PUFA in a drink significantly affects the oxidation process. Addition of CO₂ has even a better effect than using nitrogen in headspace, which was unexpected.

Consequently, it has been shown that the carbonated compositions according to the invention are more stable than non-carbonated reference samples. The carbonated compositions according to the invention are even more stable than reference samples containing N₂ in headspace.

1. Beverage, comprising polyunsaturated fatty acids (PUFA) or derivatives thereof in an oil-in-water emulsion wherein said beverage is carbonated.

2. Beverage according to claim 1, wherein the PUFAs or derivatives thereof is an oil extracted from an animal or vegetable source.

3. Beverage according to claim 1 or 2, wherein said oil is of marine origin, preferably fish or krill oil.

4. Beverage according to claim 1, wherein the content of oil is from 0.1-7% by weight based on the total weight.

5. Beverage according to claim 1, wherein the emulsifier suitable for making the oil-in-water emulsion is milk solids.

6. Beverage according to claim 1, wherein the emulsifier suitable for making the oil-in-water emulsion is whey protein concentrate.

7. Beverage according to claim 1, further comprising juice either in the form of a concentrate or fresh pressed juice.

8. Beverage according to claim 1, wherein said juice originates from fruit, berry or vegetables having a suitable high level of antioxidants.

9. Beverage to claim 8, wherein the juice is selected from the group of apple, pomegranate, apricot, grapefruit, orange, cranberry, rosehips, pineapple, black chokeberries (aronia), mulberry, cloudberry, acerola, raspberries, watermelon, grapes, cherries, jambolao, gala apples, mango, kiwi, bilberry, blackberry, blueberry, boysenberry, gooseberry, raspberry, strawberry, carrots, banana, passion fruit, lime, mango, nectarine, peaches, plums, galia and honey dew or any combination thereof.

10. Beverage according to claim 1, further comprising probiotics.

11. Beverage according to claim 1, further comprising a sweetener, flavoring agents, antioxidants, vitamins, minerals and preservatives.

12. Beverage according to claim 1, wherein the beverage is filled on airtight bottles.

13. A process for the preparation of a beverage comprising the following steps:
a) water soluble additives are solubilised in water
b) emulsifier and oil soluble additives are mixed with the oil of interest under continuous but gentle stirring
c) the oil phase of b) is added slowly under continuous but gentle stirring to the water phase of a) obtaining a homogenous oil-in-water emulsion;
d) the resultant composition is optionally combined with suitable juice or juice concentrate,
e) CO₂ is added, and
f) the composition is filled on suitable air tight sealed containers under inert atmosphere.

14. A sealed container comprising a beverage as claimed in claim 1.
